(19) United States
(12) Patent Application Publication
(10) Pub. No.: US 2024/0071411 A1
(43) Pub. Date: Feb. 29, 2024

(54) DETERMINING DIALOG QUALITY METRICS OF A MIXED AUDIO SIGNAL

(71) Applicant: Dolby Laboratories Licensing Corporation, San Francisco, CA (US)

(72) Inventors: Jundai SUN, Beijing (CN); Lie LU, Dublin, CA (US); Shaofan YANG, Beijing (CN); Rhonda J. WILSON, San Francisco, CA (US); Dirk Jeroen BREEBAART, Ultimo, NSW (AU)

(73) Assignee: Dolby Laboratories Licensing Corporation, San Francisco, CA (US)

(21) Appl. No.: 18/259,848

(22) PCT Filed: Jan. 4, 2022
(86) PCT No.: PCT/US2022/011094

§ 371 Date: Jun. 29, 2023

Related U.S. Application Data
(60) Provisional application No. 63/147,787, filed on Feb. 10, 2021.

(30) Foreign Application Priority Data
Jan. 6, 2021 (WO) PCT/CN2021/070480
Feb. 15, 2021 (EP) 21157119.5

(51) Int. Cl. G10L 25/60; G10L 21/0272

(52) U.S. Cl. CPC G10L 25/60; G10L 21/0272

(57) ABSTRACT

Disclosed is a method for determining one or more dialog quality metrics of a mixed audio signal comprising a dialog component and a noise component, the method comprising separating an estimated dialog component from the mixed audio signal by means of a dialog separator using a dialog separating model determined by training the dialog separator based on the one or more quality metrics; providing the estimated dialog component from the dialog separator to a quality metrics estimator; and determining the one or more quality metrics by means of the quality metrics estimator based on the mixed signal and the estimated dialog component. Further disclosed is a method for training a dialog separator, a system comprising circuitry configured to perform the method, and a non-transitory computer-readable storage medium.

### CROSS-REFERENCE TO RELATED APPLICATIONS

This application claims priority of International PCT Application No. PCT/CN2021/070480, filed Jan. 6, 2021, European Patent Application No. 21157119.5, filed Feb. 15, 2021 and U.S. Provisional Application 63/147,787, filed Feb. 10, 2021, each of which is hereby incorporated by reference in its entirety.

### TECHNICAL FIELD

The present disclosure relates to metering of dialog in noise.

### BACKGROUND

Recorded dialog, e.g. human speech, is often provided over a background sound, for instance when dialog is provided on a background of sports events, background music, wind noise from wind entering a microphone, or the like.

Such background sound, hereinafter called noise, can mask at least part of the dialog, thereby reducing the quality, such as the intelligibility, of the dialog.

To estimate the dialog quality of the recorded dialog in noise, quality metering is typically performed. Such quality metering typically relies on comparing a clean dialog, i.e. the recorded dialog without noise, and the noisy dialog.

It has, however, turned out that there is a need for a more flexible dialog quality metering which can also be used where no clean dialog is available.

### SUMMARY

An object of the present disclosure is to provide an improved dialog metering.

According to a first aspect of the present disclosure, there is provided a method, the method comprising: receiving, at a dialog separator, a training signal comprising a dialog component and a noise component; receiving, at a quality metrics estimator, a reference signal comprising the dialog component; determining, in the quality metrics estimator, a first value representative of a quality metric of the training signal based on the reference signal; separating, in the dialog separator, an estimated dialog component from the training signal using a dialog separation model; providing, from the dialog separator to the quality metrics estimator, the estimated dialog component; determining, in the quality metrics estimator, a second value representative of the quality metric of the training signal based on the estimated dialog component; and updating the dialog separation model to minimize a loss function based on a difference between the first value and the second value.

Thereby, a dialog separator may be trained to provide an estimated dialog component from a noisy signal comprising a dialog component and a noise component, in which the estimated dialog component, when used as a reference signal, provides a similar value of the quality metric of the dialog as when a reference signal including only the dialog component is used. The trained dialog separator may, thus, estimate a dialog which may be used in determining a quality metric of the dialog, in turn reducing or removing the need for using a reference signal including only the dialog component.

The step of updating may be one step of the method for training the dialog separator. The step of updating the dialog separation model may be a repetitive process, in which an updated second value may be repeatedly determined based on the updated dialog separation model. The dialog separation model may be trained to minimise a loss function based on a difference between the first value and the updated second value. The step of updating the dialog separation model may alternatively be denoted as a step of training the dialog separator.

In some embodiments the step of updating the dialog separation model may be carried out over a number of consecutive steps and will use a repeatedly updated second value based on the updated dialogue separation model by minimizing the loss function based on a difference between the first value and the updated second value.

The step of training may alternatively be denoted as a step of repeatedly updating the dialog separation model, a step of continuously updating the dialog separation model, or consecutively updating the dialog separation model.

Moreover, by minimising the loss function based on the first and second values, a computationally effective training of the dialog separator may be provided, as an estimated dialog component need not be identical to the dialog without noise but may only need to have features allowing for a value of the quality metric to be determined based on the estimated dialog component which is close to a value of the quality metric of the dialog component. For example, when determining a value of a quality metric of a training signal, a similar or approximately similar value may be achieved when based on the estimated dialog component and when based on the reference dialog component.

By “dialog” may here be understood speech, talk, and/or vocalization. A dialog may hence be speech by one or more persons and/or may include a monolog, a speech, a dialogue, a conversation between parties, talk, or the like. A “dialog component” may be an audio component in a signal and/or an audio signal in itself comprising the dialog.

By “noise component” is here understood a part of the signal that is not part of the dialog. The “noise component” may hence be any background sound including but not limited to sound effects of a film and/or TV and/or radio program, wind noise, background music, background speech, or the like.

By “quality metrics estimator” is here understood a functional block which may determine values representative of a quality metric of the training signal. The values may in embodiments be a final value of the quality metric or it may alternatively in embodiments be an intermediate representation of a signal representative of the quality metric.

In one embodiment of training the dialog separator, the method further comprises receiving, at the quality metrics estimator, the training signal comprising the dialog component and the noise component, wherein the first value is further determined based on the training signal, and the second value is further determined based on the training signal.

In one embodiment of the method of training the dialog separator, determining the first value comprises determining a final quality metric value of the training signal based on the training signal and the reference signal, and wherein determining the second value comprises determining a final quality metric value of the training signal based on the training signal and the estimated dialog component.

In one embodiment of the method of training the dialog separator, determining the first value comprises determining an intermediate representation of the reference signal, and wherein determining the second value comprises determining an intermediate representation of the estimated dialog component.

In one embodiment of the method of training the dialog separator, the first value and/or the second value is determined based on two or more quality metrics, a weighting between the two or more quality metrics is applied.

In one embodiment, the method further comprises receiving an audio signal to a dialog classifier configured to exclude non-dialog signal frames; and excluding, by the dialog classifier, any non-dialog signal frames from the audio signal so as to form the training signal.

Alternatively or additionally, the method comprises the step of receiving an audio signal to a dialog classifier classifying signal frames of the audio signal as non-dialog signal frames or dialog signal frames, and excluding any signal frames classified as non-dialog signal frames from the audio signal so as to form the training signal.

A second aspect of the present disclosure relates to a method for determining a quality metric of a mixed audio signal comprising a dialog component and a noise component, the method comprising: receiving the mixed audio signal to a dialog separator configured for separating out an estimated dialog component from the mixed audio signal; receiving the mixed audio signal to a quality metrics estimator for determining a quality metric of the dialog component of the mixed audio signal; separating the estimated dialog component from the mixed audio signal by means of the dialog separator using a dialog separating model determined by training the dialog separator based on the quality metric; providing the estimated dialog component from the dialog separator to the quality metrics estimator; and determining the quality metric by means of the quality metrics estimator based on the mixed signal and the estimated dialog component.

Advantageously, the method according to the second aspect allows for a flexible determination of a dialog quality of a mixed audio signal comprising a dialog component and a noise component as the need for a separate reference signal consisting only of the dialog component may be removed or reduced. The method may, thus, determine a quality metric of the dialog in noise based on the mixed audio signal, thus not relying on a separate reference signal which may not always be present.

Moreover, by using a dialog separating model determined by training the dialog separator based on the quality metric, the computational efficiency of the method may be improved as the dialog separator may be adapted towards providing an estimated dialog component for the specific quality metric.

In one embodiment of the method, the step of determining the quality metric comprises using the estimated dialog component as a reference dialog component.

In one embodiment of the method, in the step of separating the estimated dialog component from the noise component, the dialog separator uses a dialog separating model determined by training the dialog separator based on minimizing a loss function based on the quality metrics.

In one embodiment, the determined quality metric is used in estimating a quality of the dialog component of the mixed signal.

In one embodiment of the method, the quality metric is a Short-Time Objective Intelligibility, STOI, metric.

The quality metric may alternatively be a STOI metric.

In one embodiment of the method, the quality metric is a Partial Loudness, PL, metric.

The quality metric may alternatively be a Partial Loudness metric.

In one embodiment of the method, the quality metric is a Perceptual Evaluation of Speech Quality, PESQ, metric.

The quality metric may alternatively be a PESQ metric.

In one embodiment, the method further comprises the step of receiving the mixed audio signal to a dialog classifier, classifying, by the dialog classifier, signal frames of the mixed audio signal as non-dialog signal frames or dialog signal frames, and excluding any signal frames classified as non-dialog signal frames from the mixed audio signal.

By the term “frame” should, in the context of the present specification, be understood a section or segment of the signal, such as a temporal and/or spectral section or segment of the signal. The frame may comprise or consist of one or more samples.

In one embodiment of the method, the mixed audio signal comprises a present signal frame and one or more previous signal frames.

In one embodiment, the method further comprises the step of: applying to the quality metric a compensation for systematic errors by means of a compensator.

In some embodiments of the method, the dialog separating model is determined by training the dialog separator according to the method of the first aspect of the present disclosure.

A third aspect of the present disclosure relates to a system comprising circuitry configured to perform the method according to the first aspect of the disclosure or the method according to the second aspect of the disclosure.

A fourth aspect of the present disclosure relates to a non-transitory computer-readable storage medium comprising instructions which, when executed by a device having processing capability, causes the device to carry out the method according to the first aspect of the present disclosure or the method according to the second aspect of the present disclosure.

### BRIEF DESCRIPTION OF THE DRAWINGS

Embodiments of the present invention will be described in more detail with reference to the appended drawings.

FIG. 1 shows a flow chart of an embodiment of a method for training a dialog separator according to the present disclosure,

FIG. 2 shows a flow chart of an embodiment of a method for determining one or more dialog quality metrics of a mixed audio signal according to the present disclosure,

FIG. 3 shows a schematic block diagram of a system comprising a mixed audio signal, a dialog separator, and a quality metric estimator, and

FIG. 4 shows a schematic block diagram of a device comprising circuitry configured to perform the method.

### DETAILED DESCRIPTION

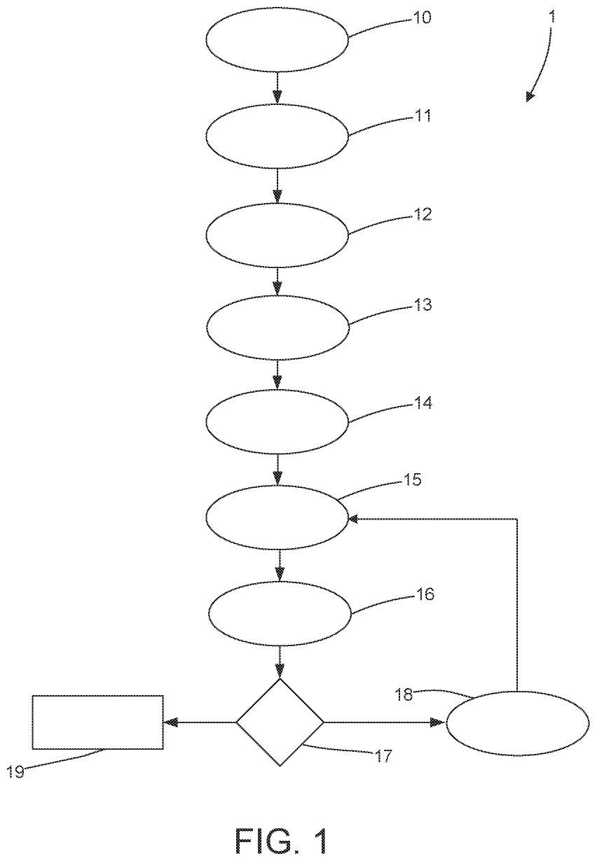

FIG. 1 shows a flow chart of an embodiment of a method 1 according to the present disclosure. The method 1 may be a method for training a dialog separator. The method 1 comprises: the step 10 of receiving, to a dialog separator, a training signal comprising a dialog component and a noise component.

The training signal may be an audio signal. The training signal may comprise the dialog component and the noise component included in one single audio track or audio file. The audio track may be a mono audio track, a stereo audio track, or a surround audio track. The training signal may resemble in type and/or format to a mixed audio signal.

The dialog separator may comprise or may be a dialog separator function. The dialog separator may be configured to separate an estimated dialog component from an audio signal comprising the dialog component and a noise component

The training signal may in step 10 be received by means of wireless or wired communication.

In a first embodiment, the method 1 further comprises the step 11 of receiving, to a quality metrics estimator, the training signal comprising dialog component and noise component. In a second embodiment, this step 11 is not required.

The quality metrics estimator may comprise or may be a quality metrics determining function.

The training signal may in step 11 be received at the quality metrics estimator by means of wireless or wired communication.

The method 1 further comprises the step 12 of receiving, to the quality metrics estimator, a reference signal comprising the dialog component.

The reference signal may allow a quality metric estimator to extract a dialog component. The dialog component may be and/or may correspond to a “clean” dialog, such as a dialog without a noise component. Where the reference signal comprises further components, the reference signal may allow the quality metric estimator to extract the dialog component.

The reference signal may in some embodiments consist of and/or only comprise the dialog component. Alternatively or additionally, the reference signal may correspond to and/or consist of the training signal without the noise component. The reference signal may alternatively or additionally be considered a “clean” dialog.

The reference signal received at the quality metrics estimator in step 12 consists of the dialog component.

The method further comprises the step 13 of determining, in the quality metrics estimator, a first value representative of a quality metric of the training signal based on the reference signal.

The first value may be a value of a quality metric. Alternatively or additionally, the first value may be determined based on one or more frames of the reference signal and/or one or more frames of the training signal. The first value may be based on the training signal and the dialog component of the reference signal.

In the first embodiment, the first value determined in step 13 is further determined based on the training signal and is a final quality metric value of the training signal based on the reference signal, i.e. the dialog component. In a second embodiment, the first value determined in step 13 is an intermediate representation of the dialog component. The intermediate representation of the dialog component may for example be sub-band power values of the respective signals.

The final quality metric value of the first value in step 13 according to the first embodiment may be determined as a final value of STOI, i.e. an intelligibility measure determined based on a correlation between a short-time temporal envelope vector of each of the sub-bands of the training signal and of the reference signal. For instance, for STOI, the final quality metric value may be calculated as a measure of the similarity between the sub-band envelope over a number of frames of the training signal and the reference signal.

A “final quality metric value” and/or “final value of the quality metric” may in the context of the present specification, be an intelligibility value, resulting from a determination of the quality metric value. The final quality metric value may be the result of a predetermined quality metric. For instance, the final quality metric value may be an intelligibility value, where STOI is used as quality metric, a partial loudness value, where PL is used as quality metric, and/or a final PESQ value, where PESQ is used as quality metric.

The method 1 further comprises the step 14 of separating, in the dialog separator, an estimated dialog component from the training signal using a dialog separation model.

The dialog separation model may comprise a number of parameters, which are adjustable to adapt the performance of the dialog separation model. The parameters may initially each have an initial value. Each of the parameters may be adjusted, such as gradually adjusted, to an intermediate parameter value and/or a set of intermediate parameter values and subsequently set to a final parameter value.

The dialog separation model may be a model based on machine learning and/or artificial intelligence. The dialog separation model may comprise and/or be a deep-learning model and/or a neural network. Where the dialog separation model comprises a number of parameters, such parameters may be determined using a deep-learning model, a neural network, and/or machine learning.

The method 1 further comprises the step 15 of providing, from the dialog separator to the quality metrics estimator, the estimated dialog component.

The estimated dialog component provided in step 15 is an output of the dialog separator.

The method 1 further comprises the step 16 of determining, in the quality metrics estimator, a second value representative of the quality metric of the training signal based on the training signal and the estimated dialog component.

The second value may be a second value of the quality metric. Additionally or alternatively the second value may be determined based on one or more frames of the estimated dialog component and/or one or more frames of the training signal.

The second value may be determined as described with respect to the first value, however based on the estimated dialog component. The second value may, thus, have a similar format, such as a numerical value, as the first value. The second value of the quality metric may be of the same quality metric as the first value. The second value may be determined using STOI, PL, and/or PESQ as quality metric.

In the first embodiment, the second value in step 16 is further determined based on the training signal and is a final quality metric value of the training signal based on the estimated dialog component. In the second embodiment the second value in step 16 is an intermediate representation of the estimated dialog component. The intermediate representation of the estimated dialog component may for example be sub-band power values of the respective signals.

The final quality metric value of the second value in step 16 according to the first embodiment may be determined as a final value of STOI, i.e. an intelligibility measure determined based on a correlation between a short-time temporal envelope vector of each of the sub-bands of the training signal and of the estimated dialog component. For instance, for STOI, the final quality metric value may be calculated as a measure of the similarity between the sub-band envelope over a number of frames of the training signal and the reference signal.

The quality metrics estimator may, in determining the first value and/or the second value, use one or more quality metrics and/or may determine one or more values of the quality metric(s). For instance, the quality metrics estimator may use one or more dialog quality metrics, such as STOI, Partial Loudness, or PESQ.

The quality metrics estimator may determine the first value and/or the second value of the quality metric as an intelligibility measure and/or may be based on an intelligibility measure.

In a determination of a final value of the quality metric may comprise one or more of a frequency transformation, such as a short-time Fourier transform (STFT), a frequency band conversion, a normalisation function, an auditory transfer function, such as a head-related transfer function (HRTF), binaural unmasking prediction, and/or loudness mapping.

For instance, where STOI is used as a dialog quality metric, the quality metrics estimator may apply to the reference signal a frequency domain transformation, such as a short-time Fourier transform (STFT) and a frequency band conversion, e.g. into ⅓^{rd} octave bands. In some embodiments a normalisation and/or clipping is furthermore applied. Similarly, the quality metrics estimator may, in the case apply a frequency domain transformation and frequency band conversation and optionally normalisation and/or clipping to the training signal, and the output from this process may be compared with the representation of the reference signal to reach an intelligibility measure.

Various other dialog quality metrics may be used in which the quality metrics estimator may in steps 13 and/or 16 apply various signal processing to the respective signals, such as loudness models, level aligning, compression models, head-related transfer functions, and/or binaural unmasking.

The first and/or the second value may be based on an intelligibility measure. Alternatively or additionally, the first value may be based on features relating to an intermediate representation of the reference signal and of the estimated dialog component, respectively. An intermediate representation of a signal may for instance be a frequency or a frequency band representation, such as a spectral energy and/or power difference between the reference signal and the training signal, potentially in a frequency band.

In some embodiments, an intermediate representation is dependent on the one or more dialog quality metrics. The intermediate representation may be a value of the quality metric and/or may be based on a step in a determination of a final value of the quality metric. When STOI is used as a dialog quality metric, an intermediate representation may for instance be a spectral energy and/or power, potentially based on a STFT, of the training signal, the estimated dialog component, and/or the dialog component, and/or one or more sub-band, i.e. ⅓^{rd} octave band, energy and/or power values of the training signal, the estimated dialog component, and/or the dialog component. Where other dialog quality metrics are used, intermediate representations may comprise and/or be energy values and/or power values of sub-bands, such as equivalent rectangular bandwidth (ERB) bands, Bark scale sub-bands, and/or critical bands, may be used. In some embodiments, the intermediate representation may be a sub-band energy and/or power, to which a loudness mapping function, and/or a transfer function, such as an HRTF, may be applied.

For instance, where the dialog quality metrics is or comprises PL, an intermediate representation of the training signal, the estimated dialog component, or the dialog component may comprise one or more of a spectral energy and/or power, potentially based on a STFT, of the training signal, the estimated dialog component, or the dialog component, respectively. The intermediate representation of the training signal, the estimated dialog component, and/or the dialog component may comprise one or more sub-band, i.e. ERB and/or octave band, energy and/or power values, potentially applied a transfer function, such as a HRTF, of the respective signal/component.

For instance, where the dialog quality metrics is or comprises PESQ, an intermediate representation of the training signal, the estimated dialog component, or the dialog component may comprise a level aligned respective signal, a spectral energy and/or power, potentially based on a STFT, of respective signal/component. The intermediate representation of the training signal, the estimated dialog component, and/or the dialog component may comprise one or more sub-band, Bark scale frequency band, energy and/or power values, potentially applied a loudness mapping function, of the respective signal/component.

In steps 13 and 16, the final quality metric values are final STOI values. In other embodiments, the final quality metric value may comprise and/or be a final value of a PL quality metric and/or a final value of a PESQ quality metric. A final quality metric value of a STOI quality metric, a PL quality metric, and a PESQ quality metric may throughout this specification be denoted as a final STOI value, a final PL value, and a final PESQ value.

The first value may, where this is a final STOI value, be based on an Envelope Linear Correlation (ELC) of a respective band envelope of a sub-band of the training signal and a respective band envelope of the sub-band of the reference signal. Correspondingly, the second value may, where this is a final STOI value, be based on an ELC of a respective band envelope of a sub-band of the training signal and a respective band envelope of the sub-band of the estimated reference signal. For the first and/or second values, where these are based on an ELC, the l2 norm of the corresponding gradient of the ELC may be found to approach zero, for the correlation going towards perfect correlation, i.e. the gradient being zero for the first value when respective sub-bands of the training signal and of the reference signal are perfectly correlated and for the second value when respective sub-bands of the training signal and the estimated dialog component are perfectly correlated.

For instance, a final PL value may be determined as a sum of specific loudness measures based on the excitation of the reference signal and of the training signal in each critical band. The final quality metric value of a PL quality metric may, thus, for instance be found as:

N_{PL}=Σ_{b}N′(b)=Σ_{b}[(E_{dig}+Eₙₒᵢₛₑ+A)^{a}]−[(Eₙₒᵢₛₑ+A)^{a}−A^{a}]
wherein N_{PL} is the final quality metric value of the PL quality metric, b is a critical band, N′(b) is a specific loudness in band b, E_{dig} is the excitation level of the reference signal in the band b, Eₙₒᵢₛₑ is the excitation of unmasked noise of the training signal, unmasked based on the reference signal, in the band b, A reflects the absolute hearing threshold in band b, and a is a compression coefficient.

Where the quality metric comprises and/or is PESQ, the final quality metric value may be determined based on symmetric and asymmetric loudness densities in Bark scale frequency bands of the training signal and of the reference signal.

The first value and/or the second value may comprise a sum of the three of or any two of a final STOI value, a final PL value, and a final PESQ value. Potentially, where the first value and/or the second value comprises a sum of two or three of a final STOI value, a final PL value, and a final PESQ value, a weight may be applied between the final values. Potentially, the weight comprises a weighting value and/or a weighting factor, which may for each of the final values be a reciprocal value of a maximum value of the respective final value.

The weight may alternatively or additionally be a weighting function. The weight may comprise one or more weighting values and/or factors

The method 1 further comprises updating the dialog separation model to minimize a loss function based on a difference between the first value and the second value.

For illustrative purposes the updating of the dialog separation model is, in the method 1 shown in FIG. 1, illustrated as a step 17 of determining whether the training has ended and, if not, performing the step 18 of adapting the dialog separator model and returning to step 15. If it is determined in step 18 that the training has ended, the method 1 ends with step 19, in which configures the dialog separator. The step of updating may be a recurring step, potentially so as to train the dialog separator. The step of updating the dialog separation model may, alternatively, be denoted as the step of training the dialog separator. It will, however, be appreciated that the training step may alternatively be illustrated as and/or described in the context of one single step, in which the loss function is determined and the dialog separating model is updated, potentially repeatedly.

In step 17 of adapting the dialog separator model, a loss function is determined. The loss function is based on a difference between the first value and the second value.

The loss function may be calculated e.g. as a numeric difference between the first value and the second value, and/or the dialog separation model in step 18 may be updated to minimize a loss function comprising or being a mean absolute error (MAE) of an absolute difference the first value and the second value. The dialog separation may in step 18 be updated to minimize a loss function of a mean squared error (MSE) between the first value and the second value, i.e. to minimize the squared numeric difference between the first value and the second value.

In some embodiments, potentially where the first and second values comprise intermediate representations of the reference signal and the estimated dialog component, the loss function may be based on a weighted sum of a spectral loss and a final STOI value. The loss function may in this case be:

Loss=WspecLossspec+W_{STOI}Loss_{STOI}
where w_{spec} is a weighting factor between 0 and a value related to the power of the input, Loss_{spec} is a spectral power loss of the estimated dialog component and the reference signal (reference dialog component), W_{STOI} is a weighting factor between 0 and 1, and LOSS_{STOI} is a final STOI loss value. The final STOI loss value may be based on one or more correlation values. The loss function of step 18 is based on STOI using a weighted spectral loss and a weighted final STOI loss value.

Potentially, the final STOI loss value may be based on the first and second values being final STOI values. The final STOI loss value may be minimised using a gradient-based optimization method, such as a Stochastic Gradient Descent (SGD).

Alternatively or additionally, the loss function may, e.g. where the first and second values are and/or comprise an intermediate representation of the reference signal and of the estimated dialog component, respectively, comprise a loss factor relating to the intermediate representations of the reference signal and the estimated dialog component, respectively. The loss factor may be determined based on either the first value or the second value. The loss function may be and/or represent a difference between an intermediate representation of the estimated dialog component and an intermediate representation of the reference signal. For instance, for the loss factor may be 1/N_{dim}. The first value of the loss function may, hence, be:

$$Loss = \frac{1}{{N}_{dim}} \cdot {\sum }_{i = 1}^{{N}_{dim}} \vert {y}_{r}^{′} - {y}_{r} \vert$$

where yᵣ′ is based on an intermediate representation of the estimated dialog component and yᵣ is based on an intermediate representation of the dialog component of reference signal, and N_{dim} is a dimension the of yᵣ′ and yᵣ, respectively. The value of yᵣ′ may be one or more of a spectral power of the estimated dialog component, a spectral power difference between the estimated dialog component and the training signal, a sub-band power of the estimated dialog component, a sub-band power difference between the estimated dialog component and the training signal, or a final quality metric value based on the estimated dialog component. The value of yᵣ may correspondingly be one or more of a spectral power of the dialog component, a spectral power difference between the dialog component and the training signal, a sub-band power of the dialog component, a sub-band power difference between the dialog component and the training signal, or a final quality metric value of the reference signal.

Correspondingly, N_{dim} may correspond to one or more the number of frequency bins of the estimated dialog component and/or the dialog component, respectively, the number of sub-bands, and/or the dimension of a final quality metric value.

By using an intermediate representation in the loss function, the computational complexity may, thus, be reduced. For instance, where STOI is used, the intermediate representation of the training signal, of the estimated dialog component, and/or of the reference signal may be a spectral power of a 128 bin STFT based on 128 samples long frame of the training signal, the estimated dialog component, and/or of the reference signal, respectively, or on a sub-band power of the ⅓^{rd} octave bands of the respective signal(s). Where STOI is the quality metric, the intermediate representation may be the power of the 30⅓^{rd} octave bands of the respective signal(s), in turn allowing for a reduced input dimension. For PL, the intermediate representation may e.g. be the power of the 40 bands of the ERB or the 24 bands on the Bark scale, where PESQ for example is or is comprised in the quality metric.

The loss function may, alternatively or additionally be determined based on an intermediate representation of the estimated dialog component, an intermediate representation of the reference signal, a final quality metric value of the training signal based on the estimated dialog component, and a final quality metric value of the training signal based on the reference signal. Potentially, the loss function may further be determined based on an intermediate representation of the training signal.

The quality metric may comprise one or more of STOI, PL, and PESQ. Where the quality metric comprises two or more of STOI, PL, and PESQ, a loss function may be determined based on intermediate representations relating to the two or more of STOI, PL, and PESQ and/or final quality metric values of the two or more of STOI, PL, and PESQ. The loss function may be a, potentially weighted, sum of one or more of a final STOI loss value, a final PL loss value, a final PESQ loss value, and one or more loss factors determined based on the intermediate representations.

As an example, the loss function may be determined. The loss function may, in this case, be applied a weighting, e.g. by the weight. The weighting may comprise a plurality of weighting values, potentially one for each of the final quality metric loss values and for each of the loss values determined based on intermediate representations. An exemplary loss function may thus be:

Loss=w₁Loss_{spec}+w₂Loss_{STOI}+W₃Loss_{PL}+W₄Loss_{PESQ}
where w₁, w₂, w₃, and w₄ are respective weighing values and LOSS_{PL} is a final PL loss value and LOSS_{PESQ} is a final PESQ loss value. Loss_{spec} may be a sum of weighted intermediate representations losses, such as a weighted sum of losses of a plurality of intermediate representations, each intermediate representation potentially relating to a respective quality metric.

The loss function may alternatively be a weighted sum of a plurality of final scores, each being a final score of a quality metric multiplied by a respective weighting value. For instance, the loss function may be

Loss=w₁Loss_{STOI}+w₂Loss_{PL}+w₃Loss_{PESQ}

Alternatively, the loss function may be a weighted sum of losses of intermediate representations, potentially each relating to a respective quality metric. For instance, the loss function may be

Loss=w₁Loss_{spec,STOI}+W₂LOSS_{spec,PL}+W₃LoSS_{Spec}_{_{PESQ}}

In determining the loss function in step 17, the weighting values are determined as or estimated to be a reciprocal value of the maximum value of the respective loss. Thereby, each of the weighted final quality metric loss values will yield a result between 0 and 1. In other embodiments, different weightings may be applied, so that some of the loss values, such as the loss values determined based on intermediate representations or one or more of the final loss values, may lie within a different range or different ranges. Thereby, some loss values may carry a larger weight when the loss function is to be minimised and may consequently influence the process of minimising the loss more than the remaining loss values.

The step of training the dialog separator may be carried out by means of a machine-learning data architecture, potentially being and/or comprising a deep-learning data architecture and/or a neural network data structure.

Step 17 of determining whether the training has ended of the method 1 shown in FIG. 1 may be based on the determined value of the loss function.

In some embodiments, the method may further comprise the step of receiving an audio signal to a dialog classifier configured to exclude non-dialog signal frames; and excluding, by the dialog classifier, any non-dialog signal frames from the audio signal so as to form the training and/or reference signal. The step of excluding any non-dialog signal frames so as to form the training signal and/or reference signal may be carried out before steps 13-19. The audio signal may comprise dialog signal frames, comprising a dialog component and a noise component, and non-dialog signal frames, in which no dialog is present. Alternatively or additionally, the method may comprise a step of separating, by a dialog classifier configured to exclude non-dialog signal frames, a non-dialog element from the training signal and/or the reference signal. The step of separating a non-dialog element from the training signal and/or the reference signal may potentially be carried out prior to the step of training the dialog separator, i.e. prior to steps 17, 18, and 19. By excluding and/or separating non-dialog elements from the training and/or reference signal, an improved dialog separation model may be provided, as the dialog separation model may be trained and/or updated based only on signal elements comprising speech.

In the step of excluding the non-dialog element, a dialog element may be defined as one or more frames of the training and/or reference signal which contain dialog energy above a predefined threshold based on the reference signal and/or the estimated dialog component, a predefined threshold sound-noise ratio (SNR) of the reference signal and/or the estimated dialog component and the training signal, and/or a threshold final PL value. Where a threshold is used, this threshold may be based on a maximum energy of the training signal, the reference signal and/or the estimated dialog component, such as determined as the maximum energy minus a predetermined value, e.g. the maximum energy minus 50 decibels.

A non-dialog element may, hence, be identified as one or more frames which do not contain speech energy above the threshold, above the predefined SNR, and/or having a final PL value above the threshold final PL value. A such non-dialog element may, then be separated from the training signal, the estimated dialog component, and/or the reference signal. Alternatively or additionally, the non-dialog element may be removed when it exceeds a certain predetermined threshold time length, such as 300 milliseconds.

The dialog classifier may be any known dialog classifier. In some embodiments, the dialog classifier may provide a loss value which may be used in the loss function determined in the step of training the dialog separator illustrated by steps 17, 18, and 19 in the method 1 of FIG. 1.

In some embodiments, the method further comprises applying step of applying, by means of a compensator, a compensation value to the loss function and/or any one or more final quality metric loss values potentially used in the loss function. The compensator may comprise and/or may be a compensation function. The compensator may comprise and/or be a compensation curve.

Thereby, the risk that an estimated dialog is over- or under-estimated may be reduced.

The compensation may be determined by analysing the statistical difference between one or more quality metric values, e.g. a first value, of the training signal based on the reference signal and one or more quality metric values, e.g. a second value, of the training signal based on the estimated dialog component. In some embodiments, the compensation may at least partially be dependent on a SNR value of the training signal based on the estimated dialog component and/or a SNR value of the training signal based on the reference signal.

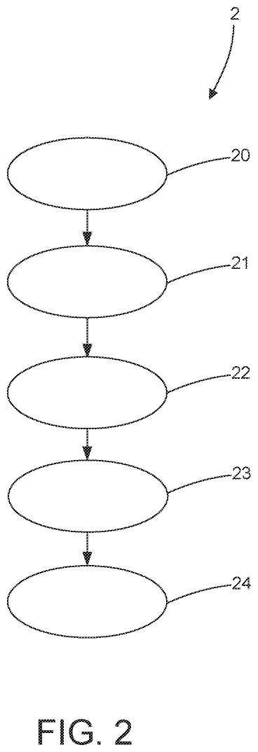

FIG. 2 shows a flow chart of an embodiment of a method 2 for determining one or more dialog quality metrics of a mixed audio signal according to the present disclosure.

Functions and/or features of the method 2 having names identical with those of the method 1 described with respect to FIG. 1 may correspond to and/or be identical to the respective functions and/or features of method 1.

In the method 2 shown in FIG. 2, one or more dialog quality metrics of a mixed audio signal comprising a dialog component and a noise component are determined. The method 2 comprises the step 20 of receiving the mixed audio signal to a dialog separator configured for separating out an estimated dialog component from the mixed audio signal.

The dialog separator is, in the method 2 of FIG. 2, a dialog separator using a dialog separating model determined by training the dialog separator based on the one or more quality metrics. Hence, the dialog separator may for example be a dialog separator trained according to the method 1 shown in FIG. 1. The dialog separator may thus be a dialog separator as described with respect to the method 1 of FIG. 1. The dialog separator in the method 2 of FIG. 2 may alternatively or additionally comprise any number of features described with respect to the dialog separator of the method 1 of FIG. 1.

The method 2 further comprises the step 21 of receiving the mixed audio signal to a quality metrics estimator for determining a quality metric of the dialog component of the mixed audio signal.

The quality metrics estimator of the method 2 of FIG. 2 may be configured to determine a quality metric and/or a value of a quality metric of the mixed audio signal. The quality metrics estimator of the method 2 of FIG. 2 may, similarly, be a quality metrics estimator as described with respect to the method 1 of FIG. 1. The quality metrics estimator in the method 2 of FIG. 2 may alternatively or additionally comprise any number of features described with respect to the quality metrics estimator of the method 1 of FIG. 1.

The method 2 further comprises the step 22 of separating the estimated dialog component from the mixed audio signal by means of the dialog separator using a dialog separating model determined by training the dialog separator based on the one or more quality metrics.

The dialog separator may, for example, be trained based on the method 1 of FIG. 1.

The method 2 further comprises the step 23 of providing the estimated dialog component from the dialog separator to the quality metrics estimator.

The method 2 further comprises the step 24 of determining the one or more quality metrics by means of the quality metrics estimator based on the mixed signal and the estimated dialog component.

The one or more quality metrics may be a quality metric value, such as a final quality metrics value. In some embodiments, the one or more quality metrics may comprise a plurality of quality metric values. In step 24 of the method 2, the quality metric may be a final STOI value. In other embodiments, the quality metrics may be and/or comprise a final PL value and/or a final PESQ value.

The one or more quality metrics may in step 24 each be determined as described with reference to the determination of the first and/or second value described with respect to the method 1 shown in FIG. 1, however in step 24 based on the mixed audio signal (rather than the training signal described with respect to method 1) and the estimated dialog component. The mixed audio signal may correspond to the training signal.

The determined one or more quality metrics may be used in estimating a quality of the dialog component of the mixed signal

The step of determining the one or more quality metrics comprises using the estimated dialog component as a reference dialog component.

Thereby, the one or more quality metrics may be determined without the need of a reference signal, in turn allowing for an increased flexibility of the system.

In one embodiment of the method, in the step of separating the estimated dialog component from the noise component, the dialog separator uses a dialog separating model determined by training the dialog separator based on minimizing a loss function based on the one or more quality metrics.

The loss function determination may be as described with respect to the method 1 of training the dialog separator.

In one embodiment of the method, the one or more quality metrics comprises a Short-Time Objective Intelligibility, STOI, metric.

The one or more quality metrics may alternatively or additionally be a STOI metric.

In one embodiment of the method, the one or more quality metrics comprises a Partial Loudness, PL, metric.

The one or more quality metrics may alternatively or additionally be a Partial Loudness metric.

In one embodiment of the method, the quality metric comprises a Perceptual Evaluation of Speech Quality, PESQ, metric.

The one or more quality metrics may alternatively or additionally be a PESQ metric.

In one embodiment, the method further comprises the step of providing the receiving the mixed audio signal to a dialog classifier and separating, by a dialog classifier configured to exclude non-dialog signal frames, a non-dialog element from the mixed audio signal. Alternatively or additionally, the method may comprise the step of receiving an audio signal to a dialog classifier configured to exclude non-dialog signal frames; and excluding, by the dialog classifier, any non-dialog signal frames from the audio signal so as to form the mixed audio signal.

The dialog classifier may be as described with respect to the method 1 shown in FIG. 1.

In one embodiment of the method, the mixed audio signal comprises a present signal frame and one or more previous signal frames.

Thereby, the method may be allowed to run in and/or provide a quality metric in real-time or approximately real-time, as the need to await future frames before providing a quality metric may be removed. In the method 2 shown in FIG. 2, 29 previous frames are be comprised in the mixed audio signal. In other embodiments fewer or more previous frames may be comprised in the mixed audio signal.

In one embodiment, the method further comprises the step of: applying to the quality metric a compensation for systematic errors by means of a compensator.

Thereby, the method 2 may compensate for systematic errors. The compensator may be as described with respect to method 1.

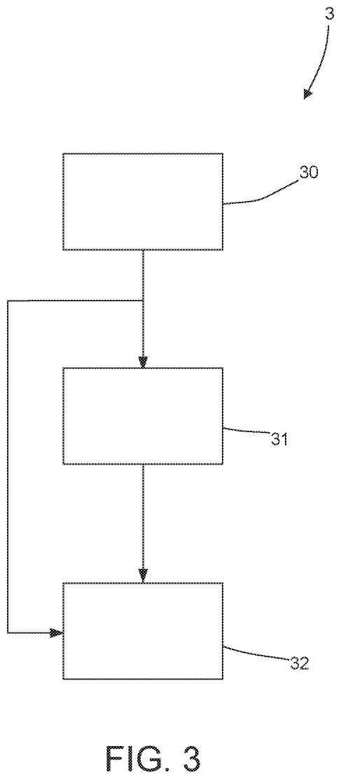

FIG. 3 shows a schematic block diagram of a system 3 comprising a mixed audio signal 30, a dialog separator 31, and a quality metric estimator 32. The system 3 is configured to perform the method 2 of determining one or more quality metrics of the mixed audio signal 30. The system may comprise circuitry configured to perform the method 1 and/or the method 2.

In FIG. 3, the mixed audio signal 30 comprises a dialog component and a noise component. The dialog separator 31 may be trained by means of the method 1.

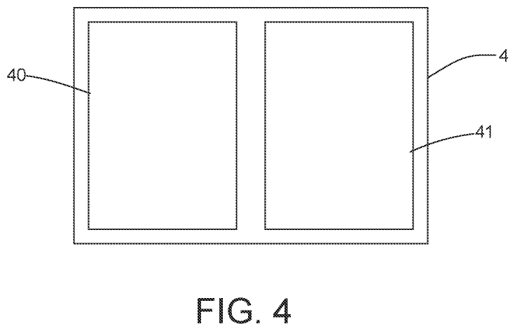

FIG. 4 shows a schematic block diagram of a device 4 comprising circuitry configured to perform the method 1 of training a dialog separator 31. The device 4 may alternatively or additionally comprise circuitry configured to perform the method 2 of determining one or more quality metrics of the mixed audio signal.

The device in FIG. 4 comprises a memory 40 and a processing unit 41.

The memory 40 stores instructions which cause the processing unit 41 to perform the method 1. The memory 40 may alternatively or additionally comprise instruction which cause the processing unit to perform the method 2 of determining one or more quality metrics of the mixed audio signal.

In some embodiments, the dialog separator 31 and/or the quality metrics estimator 32 of the system 3 may be provided by the device 4. The device 4 may furthermore comprise an input element (not shown) for receiving a training signal, a reference signal and/or a mixed audio signal. The device may alternatively or additionally comprise an output element (not shown) for reading out one or more quality metrics of a mixed audio signal.

The memory 40 may be a non-volatile memory, such as a random access memory (RAM), read-only memory (ROM), Electrically Erasable Programmable ROM (EEPROM), a flash memory, or the like.

The processing unit 41 may be one or more of a central processing unit (CPU), a microcontroller unit (MCU), a field-programmable gate array (FPGA), or the like.

### Final Remarks

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

As used herein, the term “exemplary” is used in the sense of providing examples, as opposed to indicating quality. That is, an “exemplary embodiment” is an embodiment provided as an example, as opposed to necessarily being an embodiment of exemplary quality.

It should be appreciated that in the above description of exemplary embodiments of the invention, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that more features are required than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be encompassed, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element.

In the description provided herein, numerous specific details are set forth. However, it is understood that embodiments of the invention may be practiced without these specific details. In other instances, well-known methods, structures and techniques have not been shown in detail in order not to obscure an understanding of this description.

Thus, while there has been described specific embodiments of the invention, those skilled in the art will recognize that other and further modifications may be made, and it is intended to claim all such changes and modifications. For example, any formulas given above are merely representative of procedures that may be used. Functionality may be added or deleted from the block diagrams and operations may be interchanged among functional blocks. Steps may be added or deleted to methods described.

Systems and methods disclosed hereinabove may be implemented as software, firmware, hardware or a combination thereof. For example, aspects of the present application may be embodied, at least in part, in an apparatus, a system that includes more than one device, a method, a computer program product, etc. In a hardware implementation, the division of tasks between functional units referred to in the above description does not necessarily correspond to the division into physical units; to the contrary, one physical component may have multiple functionalities, and one task may be carried out by several physical components in cooperation. Certain components or all components may be implemented as software executed by a digital signal processor or microprocessor or be implemented as hardware or as an application-specific integrated circuit. Such software may be distributed on computer readable media, which may comprise computer storage media (or non-transitory media) and communication media (or transitory media). As is well known to a person skilled in the art, the term computer storage media includes both volatile and non-volatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information, and which can be accessed by a computer. Further, it is well known to the skilled person that communication media typically embodies computer readable instructions, data structures, program modules or other data in a modulated data signal such as a carrier wave or other transport mechanism and includes any information delivery media.

Various aspects of the present invention may be appreciated from the following enumerated example embodiments (EEEs):
EEE1. A method comprising:
   receiving, at a dialog separator, a training signal comprising a dialog component and a noise component;
   receiving, at a quality metrics estimator, a reference signal comprising the dialog component;
   determining, in the quality metrics estimator, a first value representative of a quality metric of the training signal based on the reference signal;
   separating, in the dialog separator, an estimated dialog component from the training signal using a dialog separation model;
   providing, from the dialog separator to the quality metrics estimator, the estimated dialog component;
   determining, in the quality metrics estimator, a second value representative of the quality metric of the training signal based on the estimated dialog component; and updating the dialog separation model to minimize a loss function based on a difference between the first value and the second value.
EEE2. The method according to EEE 1, further comprising:
   receiving, at the quality metrics estimator, the training signal comprising the dialog component and the noise component, wherein the first value is further determined based on the training signal, and the second value is further determined based on the training signal.
EEE3. The method according to EEE 2, wherein determining the first value comprises determining a final quality metric value of the training signal based on the training signal and the reference signal, and wherein determining the second value comprises determining a final quality metric value of the training signal based on the training signal and the estimated dialog component.
EEE4. The method according to EEE 1, wherein determining the first value comprises determining an intermediate representation of the reference signal, and wherein determining the second value comprises determining an intermediate representation of the estimated dialog component.
EEE5. The method according to any one of EEEs 1 to 3, wherein the first value and/or the second value is determined based on two or more quality metrics, wherein weighting between the two or more quality metrics is applied.
EEE6. The method according to any one of the preceding EEEs further comprising:
   receiving an audio signal at a dialog classifier
   classifying, by the dialog classifier, signal frames of the audio signal as non-dialog signal frames or dialog signal frames;
   excluding any signal frames of the audio signal classified as non-dialog signal frames so as to form the training signal.
EEE7. A method for determining a dialog quality metric of a mixed audio signal comprising a dialog component and a noise component, the method comprising:
   receiving the mixed audio signal at a dialog separator configured to separate out an estimated dialog component from the mixed audio signal;
   receiving the mixed audio signal at a quality metrics estimator for determining a quality metric of the dialog component of the mixed audio signal;
   separating the estimated dialog component from the mixed audio signal by means of the dialog separator using a dialog separating model determined by training the dialog separator based on the quality metric;
   providing the estimated dialog component from the dialog separator to the quality metrics estimator; and
   determining the quality metric by means of the quality metrics estimator based on the mixed signal and the estimated dialog component.
EEE8. The method according to EEE 7, wherein the step of determining the quality metric comprises using the estimated dialog component as a reference dialog component.
EEE9. The method according to EEE 7 or 8, wherein, in the step of separating the estimated dialog component from the noise component, the dialog separator uses a dialog separating model determined by training the dialog separator based on minimizing a loss function based on the quality metric.
EEE10. The method according to any one of EEEs 7 to 9, wherein the determined quality metric are used in estimating a quality of the dialog component of the mixed signal.
EEE11. The method according to any one of EEEs 7 to 10, wherein the quality metric is a Short-Time Objective Intelligibility, STOI, metric.
EEE12. The method according to any one of EEEs 7 to 10, wherein the quality metric is a Partial Loudness, PL, metric.
EEE13. The method according to any one of EEEs 7 to 10, wherein the quality metric is a Perceptual Evaluation of Speech Quality, PESQ, metric.
EEE14. The method according to any one of EEEs 7 to 13 further comprising:
   receiving the mixed audio signal to a dialog classifier;
   classifying, by the dialog classifier, signal frames of the mixed audio signal as non-dialog signal frames or dialog signal frames; and
   excluding any signal frames of the mixed audio signal classified as non-dialog signal frames from the mixed audio signal.
EEE15. The method according to any one of EEEs 7 to 14, wherein the mixed audio signal comprises a present signal frame and one or more previous signal frames.
EEE16. The method according to any one of EEEs 7 to 15 further comprising the step of:
   applying to the quality metric a compensation for systematic errors by means of a compensator.
EEE17. The method according to any one of EEEs 7 to 16, wherein the dialog separating model is determined by training the dialog separator according to the method of any one of EEEs 1 to 6.
EEE18. A system comprising circuitry configured to perform the method of any one of EEEs 1 to 6 or the method of any one of EEEs 7 to 17.
EEE19. A non-transitory computer-readable storage medium comprising instructions which, when executed by a device having processing capability, causes the device to carry out the method of any one of EEEs 1 to 6 or the method of any one of EEEs 7 to 17.

1-17. (canceled)

18. A method comprising:
receiving, at a dialog separator, a training signal comprising a dialog component and a noise component;
receiving, at a quality metrics estimator, a reference signal comprising the dialog component;
determining, in the quality metrics estimator, a first value representative of a quality metric of the training signal based on the reference signal;
separating, in the dialog separator, an estimated dialog component from the training signal using a dialog separation model;
providing, from the dialog separator to the quality metrics estimator, the estimated dialog component;
determining, in the quality metrics estimator, a second value representative of the quality metric of the training signal based on the estimated dialog component; and
updating the dialog separation model to minimize a loss function based on a difference between the first value and the second value,
the method further comprising:
receiving, at the quality metrics estimator, the training signal comprising the dialog component and the noise component,
wherein the first value is further determined based on the training signal, and the second value is further determined based on the training signal.

19. The method according to claim 18, wherein determining the first value comprises determining a final quality metric value of the training signal based on the training signal and the reference signal, and wherein determining the second value comprises determining a final quality metric value of the training signal based on the training signal and the estimated dialog component.

20. The method according to claim 18, wherein determining the first value comprises determining an intermediate representation of the reference signal, and wherein determining the second value comprises determining an intermediate representation of the estimated dialog component.

21. The method according to claim 18, wherein the first value and/or the second value is determined based on two or more quality metrics, wherein weighting between the two or more quality metrics is applied.

22. A method for determining a dialog quality metric of a mixed audio signal comprising a dialog component and a noise component, the method comprising:
receiving the mixed audio signal at a dialog separator configured to separate out an estimated dialog component from the mixed audio signal;
receiving the mixed audio signal at a quality metrics estimator for determining a quality metric of the dialog component of the mixed audio signal;
separating the estimated dialog component from the mixed audio signal by means of the dialog separator using a dialog separating model determined by training the dialog separator based on the quality metric;
providing the estimated dialog component from the dialog separator to the quality metrics estimator; and
determining the quality metric by means of the quality metrics estimator based on the mixed signal and the estimated dialog component.

23. The method according to claim 22, wherein the step of determining the quality metric comprises using the estimated dialog component as a reference dialog component.

24. The method according to claim 22, wherein, in the step of separating the estimated dialog component from the noise component, the dialog separator uses a dialog separating model determined by training the dialog separator based on minimizing a loss function based on the quality metric.

25. The method according to claim 22, wherein the determined quality metric are used in estimating a quality of the dialog component of the mixed signal.

26. The method according to claim 22, wherein the quality metric is one of a Short-Time Objective Intelligibility, STOI, metric, a Partial Loudness, PL, metric, and a Perceptual Evaluation of Speech Quality, PESQ, metric.

27. The method according to claim 22, wherein the mixed audio signal comprises a present signal frame and one or more previous signal frames.

28. The method according to claim 22 further comprising the step of:
applying to the quality metric a compensation for systematic errors by means of a compensator.

29. A system comprising circuitry configured to perform the method of claim 18.

30. A system comprising circuitry configured to perform the method of claim 22.

31. A non-transitory computer-readable storage medium comprising instructions which, when executed by a device having processing capability, causes the device to carry out the method of claim 18.

32. A non-transitory computer-readable storage medium comprising instructions which, when executed by a device having processing capability, causes the device to carry out the method of claim 22.

33. A method for determining a dialog quality metric of a mixed audio signal comprising a dialog component and a noise component, the method comprising:
receiving the mixed audio signal at a dialog separator configured to separate out an estimated dialog component from the mixed audio signal;
receiving the mixed audio signal at a quality metrics estimator for determining a quality metric of the dialog component of the mixed audio signal;
separating the estimated dialog component from the mixed audio signal by means of the dialog separator using a dialog separating model, wherein the dialog separating model is determined by training the dialog separator based on the quality metric to provide an estimated dialog component from a noisy signal comprising a dialog component and a noise component, in which the estimated dialog component, when used as a reference signal, provides a similar value of the quality metric of the dialog as when a reference signal including only the dialog component is used;
providing the estimated dialog component from the dialog separator to the quality metrics estimator; and
determining the quality metric by means of the quality metrics estimator based on the mixed signal and the estimated dialog component.

34. A method for determining a dialog quality metric of a mixed audio signal comprising a dialog component and a noise component, the method comprising:
receiving the mixed audio signal at a dialog separator configured to separate out an estimated dialog component from the mixed audio signal;
receiving the mixed audio signal at a quality metrics estimator for determining a quality metric of the dialog component of the mixed audio signal;
separating the estimated dialog component from the mixed audio signal by means of the dialog separator using a dialog separating model, wherein the dialog separating model is determined by training the dialog separator according to the method of claim 18;
providing the estimated dialog component from the dialog separator to the quality metrics estimator; and
determining the quality metric by means of the quality metrics estimator based on the mixed signal and the estimated dialog component.
